(19) United States
(12) Patent Application Publication
(10) Pub. No.: US 2011/0311937 A1
(43) Pub. Date: Dec. 22, 2011

(54) Orthodontic Space Closing Appliances

(75) Inventor: Andrew McCance, West Sussex (GB)

(73) Assignee: ORTHO-PRO-TEKNICA LIMITED, West Sussex, GB (UK)

(21) Appl. No.: 13/057,986

(22) PCT Filed: Aug. 5, 2009
(86) PCT No.: PCT/GB09/01930

§ 371 Date: May 16, 2011

(30) Foreign Application Priority Data
Aug. 6, 2008 (GB) 0814417.2
Aug. 5, 2009 (GB) 2009/001930

(51) Int. Cl. A61C 7/00; A61C 7/20

(52) U.S. Cl. 433/20; 433/18; 433/21

(57) ABSTRACT

An orthodontic space-closing appliance has an anterior component that can be secured to the anterior part of one of the patient's dental arches; a posterior component that is slidably connected to the anterior component and that can be secured to teeth in the patient's dental arch distal to the teeth to which the anterior component is secured; and an urging member acting on the posterior and anterior components to urge those components towards one another. The posterior component has a support block that is adapted to act against the underside of an attachment fixed to the lingual surface of the tooth to which the posterior component is attached. The support block applies force to resist tipping of the tooth as the tooth is displaced anteriorly.

The present invention relates generally to the field of orthodontics and especially to orthodontic appliances that can be used in the treatment of malocclusions (i.e. misalignments of the teeth). More specifically, the invention relates to orthodontic appliances that can be used to close a space between adjacent teeth (often referred to as “space closing appliances”).

Malocclusion is the misalignment of teeth and/or an incorrect relation between the teeth of the two dental arches, giving rise to faulty contact between upper and lower teeth; i.e. a lack of normal occlusion. Correcting malocclusions is desirable for functional as well as aesthetic reasons. Uneven distribution of masticatory forces, for example, can result in excessive wear and loosening of teeth and crowding of teeth can mean cleaning is more difficult leading to increased plaque and greater susceptibility to caries.

In some cases, for example when seeking to correct malocclusion in a crowded arch (i.e. where there is inadequate space for the teeth), the treatment includes the extraction of a tooth to form a space. Closing this space, by drawing the teeth on one or both sides of the space towards one another can alleviate the crowding of the teeth in the arch as one step towards creating a normal or near-normal occlusion. In other cases, it is necessary to close naturally occurring spaces between teeth, in order to move towards normal occlusion.

Conventionally, malocclusions are corrected through the use of orthodontic appliances, commonly known as “braces”, that include a series of metal or ceramic attachments that are cemented to the teeth and connected by tensioned wires that apply forces to the attachments, and hence to the teeth, to give the desired movement. Fixed appliances for space closure typically apply forces to close the space between two adjacent teeth using a looped archwire or a coil spring.

These conventional appliances are, however, not without problems. The procedures for attaching the appliances to the teeth are not straightforward and can cause discomfort, as can the installed appliance. These appliances are generally unsightly and cause problems themselves in maintaining dental hygiene, with the attachments acting as traps for food as it is chewed.

Tooth positioners are an alternative to conventional metal braces that have gained in popularity in recent years.

The concept was first proposed in the 1940s by Dr. Harold Kesling as an appliance for the final positioning of teeth following use of more conventional orthodontic appliances (see: Kesling, “The Philosophy of the Tooth Positioning Appliance”, Am. J. Orthod. Oral. Surg. (1945) 31(6):297-304). Kesling proposed a positioner made of a resilient deformable rubber that had opposed ‘U’-shape channels moulded to fit over the occlusal and incisal surfaces of the upper and lower arches respectively, applying forces to the teeth to influence their position as well as to maintain a desired relationship between the upper and lower arches. Kesling's positioners are also described in his U.S. Pat. No. 2,531,222 and another early example of a tooth positioner is seen in GB 1550777 (Suyehiro).

It is only much more recently, however, that positioners have been proposed as a realistic alternative to conventional metal braces. Recent examples of tooth positioners include those provided by Ortho-Pro-Teknica Ltd under the brand name ClearStep™ and by Align Technology, Inc. under the brand name Invisalign™.

These positioners are moulded polymeric trays or shells of generally U-shape form that fit over the teeth of the upper or lower arch. They are colourless and transparent so are aesthetically much improved compared with the conventional braces. A realignment of the teeth is achieved by using a series of positioners, each positioner typically to be worn for a period of several weeks, to incrementally reposition the teeth. The positioners can be removed by the patient themselves to allow their teeth to be cleaned avoiding the dental hygiene problems associated with the fixings of metal braces.

More severe malocclusions, however, generally cannot be corrected by re-positioning of teeth alone using these known positioners. For instance, in the case of a treatment involving space closure, it has been necessary to first use conventional fixed orthodontic appliance to close the space (and complete other coarse corrections), with the positioners subsequently being used for a final alignment of the teeth. Such comprehensive treatments have inevitably involved the use of fixed appliances with their attendant disadvantages noted above.

A general aim of aspects of the present invention is to provide space closing appliances that are removable, whilst still being effective and easy to use.

“Removable appliances” are appliances that can be removed from and replaced on a patient's dental arch relatively easily, typically by the patient themselves. This facilitates cleaning of both the device itself and the dentition. It also means that the appliance can be manufactured in the lab (or other manufacturing facility) rather than directly in the patient's mouth. The terms “removable” and “removably” used herein should be construed accordingly.

In contrast, “fixed appliances” are cemented to the dentition to fix them in place and must therefore be constructed in situ in the patient's mouth. They tend to be adjusted and eventually removed (once treatment, or the relevant phase of a treatment, is complete) by an orthodontist.

In a first aspect, the invention provides a removable orthodontic space closing appliance comprising:
an anterior removable component that can be removably secured to the anterior part of one of a patient's dental arches;
at least one posterior removable component that can be removably secured to one or more teeth in the patient's dental arch distal to the teeth to which the anterior component is secured, the posterior component being slidably connected to the anterior component; and
an urging member acting on the posterior and anterior components to urge those components towards one another.

A benefit provided by the invention is the incorporation of so called “sliding mechanics”, traditionally associated with space closure in fixed appliance orthodontics, into a removable appliance.

In most cases there will be two posterior components, one for each side of the arch, each one removably secured to a respective tooth distal to the anterior teeth of the arch to which the anterior component is secured. Typically the or each posterior component will be secured to only a single tooth, normally a posterior tooth (i.e. a bicuspid or a molar tooth).

The appliance may be for the maxillary (top) or the mandibular (bottom) arch. For some treatments, a patient may wear a space closing appliance in accordance with this aspect of the invention on each of the maxillary and mandibular arches.

Typically the anterior component will be secured at least to the tooth immediately adjacent a gap to be closed, on the anterior side of the gap. Similarly, the posterior component will be secured to the tooth immediately to the posterior side of the gap to be closed. For example, in the case where the 2^{nd} bicuspid has been extracted, the anterior component will be secured to the 1^{st} bicuspid and the posterior component will be secured to the 1^{st} molar. However, as an alternative, the posterior component may be secured to the last standing unit in the dental arcade so as to avoid space opening up between any of the posterior teeth as one of the posterior teeth is brought forwards. This is a common scenario particularly in the adult dentition. For example, where the 2^{nd} bicuspid has been extracted, the anterior component may be secured to the 1^{st} bicuspid and the posterior component may be secured to the 3^{rd} molar. The posterior component may also be secured to the 1^{st} and/or 2^{nd} molar at the same time as the 3^{rd} molar.

The anterior removable component preferably takes the form of a tooth positioner, i.e. a moulded polymeric tray or shell of generally U-shape form that fits over the teeth of the arch in question. Preferably the positioner extends from the central teeth to the tooth (or more generally teeth on each side of the arch) that are on the anterior side of the gap(s) to be closed. For instance, the positioner may extend as far back as the 1^{st} or 2^{nd} bicuspid on each side of the arch. Preferably, the anterior removable component is transparent, which may improve its aesthetic appearance.

Especially where the anterior component is a positioner, it may serve to simultaneously change the alignment of the teeth it is covering (in a known manner) at the same time as the appliance acts to close the space(s) between this anterior component and the posterior component(s). On the other hand, the anterior component (whether a positioner or not) may serve only to secure the front of the appliance in place in order to enable the space closing function, without any additional alignment function.

The (or each) posterior component may comprise a clasp, for instance a clasp that extends part way around one of both sides of crown of the tooth to which it is secured (e.g. a ‘J’ shape or ‘C’ shape clasp). The design of the clasp should enable the patient to clip and unclip the clasp from the tooth. Alternatively, the posterior element(s) may comprise a polymeric cup configured to clip over the tooth (i.e. in effect a tooth positioner-like shell that is dimensioned to fit a single tooth).

The sliding connection between the anterior component and the (or each) posterior component preferably comprises a tubular element fixed to the posterior component and a wire attached to the anterior component, the wire extending through the tubular element so that the tubular element (and therefore the posterior component) can slide along the wire. The wire and the interior of the tubular element may have complementary non-circular cross-sectional shapes (e.g. rectangular cross-sections) in order to prevent rotation of the tubular element with respect to the wire. The wire may be a conventional arch wire, e.g. with an anterior portion of the wire embedded in the anterior component, especially where that component is a positioner-like shell.

The urging member is preferably a resilient member. It may be a spring, such as a coil spring. A nickel-titanium (Ni—Ti) coil spring is preferred. Alternatively the urging member may be a screw device that can be tightened to urge the anterior and posterior components towards one another.

The resilient member can be connected to the anterior component at one end and to the posterior component at the other end and sized so that when the appliance is secured in position in the mouth the resilient member is placed under tension (i.e. stretched between the two components), to apply the desired force urging (i.e. in this case pulling) the anterior and posterior components towards one another.

Alternatively, the resilient member can be mounted behind the posterior component, to be held between the posterior component and a stop element that is located distal to the posterior member but that is fixed in position relative to the anterior member. In this case, the resilient member is configured to be compressed between the posterior component and the stop element when the appliance is located on the patient's arch, and the acts to ‘push’ the posterior element towards the anterior element (guided by the sliding connection).

In some embodiments, a pair of resilient members may be employed, one between the anterior and posterior components and one to the posterior side of the posterior side of the posterior component in the manner discussed above, so that they act together to urge the two components towards one another, thus providing the force to close the space.

Conveniently, where the sliding connection comprises a wire in the manner discussed above, the resilient member can be a coil spring mounted on the wire (i.e. with the wire passing through the spring's coils). Where two springs are used, one in front and one behind the posterior component, the wire may extend through the tubular element of the sliding connection to extend sufficiently far beyond this element to accommodate the rearmost spring, the stop element referred to above being formed or otherwise provided on or close to the distal end of the wire.

When the coil spring is mounted on the wire, it may be fixed at either end, via respective connection portions (e.g. hooks or eyes), to the anterior component and the posterior component. Preferably, the connection portions of the spring are fixed to the anterior and posterior components at points offset from the points at which the wire connects to the anterior and posterior components. Accordingly, possible interference with the sliding of the posterior component over the wire, by the connection portions, can be avoided. Furthermore, possible limitation by the connection portions of the degree to which the spring can compress between the anterior and posterior components, as the gap between the teeth closes, can be avoided.

In some embodiments, the (or each) posterior component comprises a support block (e.g. of a polymeric material) that is fixed in relation to the clasp and that can act against the underside of an attachment fixed to the lingual or buccal surface of the tooth to which the posterior component is attached, in order to apply force to keep the tooth upright as it is displaced anteriorly. The attachment may be cemented to the tooth. The block may be formed of a resilient material, e.g. an acrylic, so that if the tooth begins to tip, the block deforms and generates a restoring force that pushes against the underside of the attachment to resist the tipping. The acrylic may be ethyl ethoxyacylate, or another member of the acrylic family, offering soft spring back capability. Alternatively, or additionally, a restoring force may be generated by the wire. For example, the wire may have a curve and may have an attachment to the tooth to achieve a similar effect to the block.

In a second aspect, the invention provides an orthodontic space closing appliance comprising:
an anterior component that can be secured to the anterior part of one of a patient's dental arches;

at least one posterior component that can be secured to one or more teeth in the patient's dental arch distal to the teeth to which the anterior component is secured, the posterior component being slidably connected to the anterior component; and
an urging member acting on the posterior and anterior components to urge those components towards one another;
wherein the posterior component comprises a support block that is adapted to act against the underside of an attachment fixed to the lingual surface of the tooth to which the posterior component is attached, in order to apply force to resist tipping of the tooth as it is displaced anteriorly.

The anterior and posterior components of the appliance may be removably secured in place or, alternatively, more permanently fixed (e.g. bonded, cemented, etc) to the dentition.

Other optional features of this second aspect include those discussed above in the context of the first aspect.

Embodiments of the invention will now be described, by way of example only, with reference to the accompanying drawings, in which:

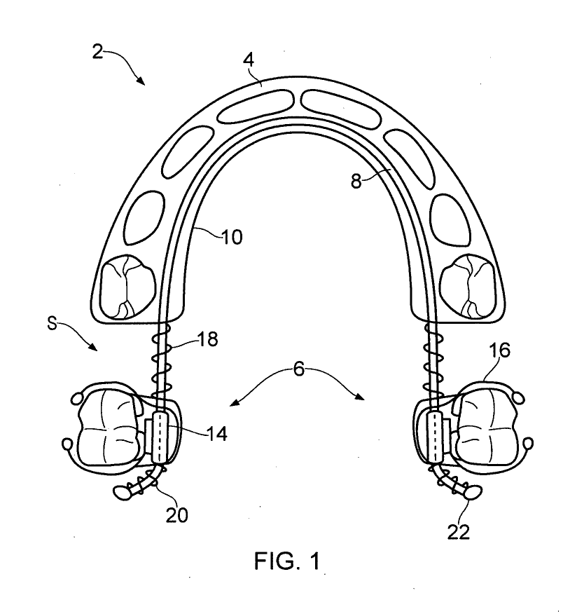

FIG. 1 is a plan view of an embodiment of a removable space closing appliance in accordance with the first aspect of the present invention, schematically showing the appliance secured in position on a patient's arch;

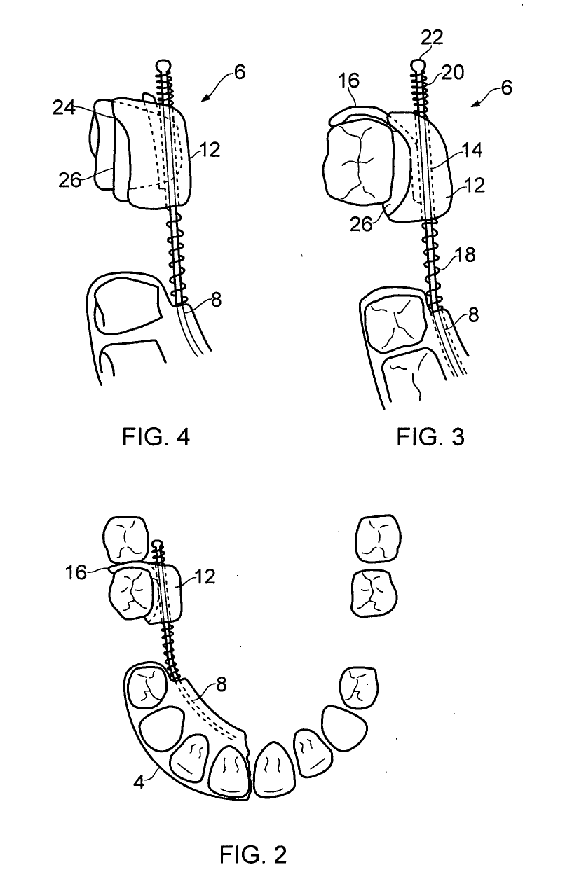

FIG. 2 is a plan view similar to that shown in FIG. 1 but illustrating only one half of the appliance and additionally showing an attachment on the tooth that can interact with the posterior component of the appliance to keep the molar upright as it is moved (in accordance with the second aspect set forth above);

FIG. 3 is a plan view, on an enlarged scale, of a posterior portion of the appliance shown in FIG. 2; and

FIG. 4 is a side view (from the lingual side of the tooth) of the portion of the appliance seen in FIG. 3.

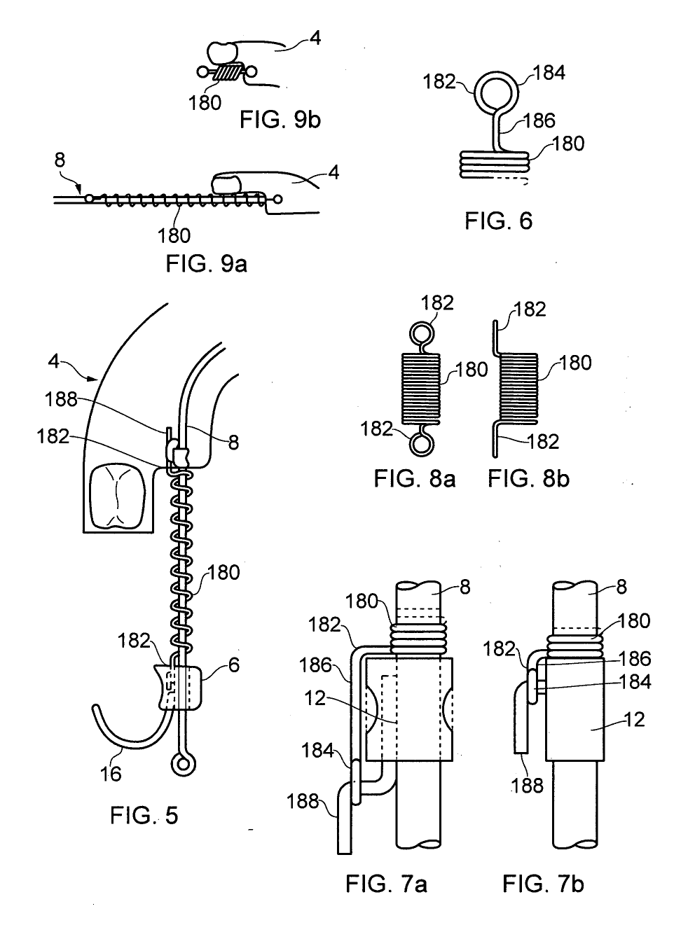

FIG. 5 is a plan view similar to FIG. 3, but showing a modified coil spring used in the appliance.

FIG. 6 is a partial side view of the spring of FIG. 5, showing a connection portion of the spring.

FIGS. 7a and 7b are plan views of the spring and posterior component shown in FIG. 5, in which the connection between the connection portions of the spring and the posterior component is shown in greater detail.

FIGS. 8a and 8b are side and plan views respectively of the spring of FIG. 5 in a compressed state.

FIGS. 9a and 9b illustrate the way in which the spring of FIG. 5 will compress between the posterior and anterior components of the appliance of FIG. 5.

The removable space closing appliance 2 of FIG. 1, as well as that of FIGS. 2 to 4, includes a single anterior component 4 and a pair of posterior components 6. When worn by a patient, the posterior components 6 are urged towards the anterior component 4, to close the space ‘S’ seen in the patient's arch.

The anterior component 4 is formed (in the same manner as known polymeric positioners) as a generally U-shaped tray or shell that fits over the teeth of the upper or lower arch. It is preferably formed of a colourless and transparent material, so is aesthetically much improved compared with the conventional braces. One suitable material is polyethylene glycol.

As can be seen in the figures, the anterior component 4 extends over all of the teeth to the anterior side of the space ‘S’.

An archwire 8, which may be stainless steel and is preferably of rectangular (or other non-circular) cross-section, is embedded in the lingual face of the anterior component 4. It may be held in place, for example, by a layer 10 of an acrylic resin material bonded over the archwire 8 onto the material of the U-shape positioner-like shell 4.

Opposite ends of the archwire 8 protrude from respective opposite ends of the anterior component 4, one to either side of the patient's arch when the appliance is in position. Each end of the wire 8 extends back beyond the space S and beyond the tooth immediately behind the space S, as seen in the figures.

The posterior components 6 have the same construction as each other, save that one is the mirror image of the other, so we will focus our discussion on one of them.

As best seen in FIGS. 2 to 4, the posterior component 6, comprises a support block 12 (in this example formed of an acrylic resin) that has an orthodontic tube 14 embedded within it. The tube extends generally front to back through the block 12 and the wire 8 extends through this tube, enabling the tube 14 (and hence the posterior component 6) to slide relative to the anterior component 4.

Also held in the support block 12 is a clasp 16. This clasp, which is generally C-shaped in the embodiment of FIG. 1 and generally J-shaped in the embodiment of FIGS. 2 to 4, is used to attach the posterior component 6 to the tooth immediately behind the space S and is the element that applies force to the tooth to move it in order to close the space S. The clasp can be attached and removed by the patient themselves as it simply clips over/around the tooth.

Two coil springs 18, 20, in these examples Ni-Ti springs, are mounted on the wire 8 adjacent each of the posterior components 6. The wire 8 extends through the coils of both springs 18, 20.

One of these springs 18 has one end secured to an end of the anterior component 4 and its other end secured to the support block 12 of the posterior component 6. The spring 18 is configured to close the gap between the two components 4, 6 by urging them together. Preferably when the appliance is out of the mouth, with the spring in a passive state, the gap between the two components is substantially closed. When the appliance is installed, the gap opens to place this spring 18 under tension, thus applying the desired force urging the space S to close.

Similarly, the second spring 20 is also positioned over the wire 8 but this spring is positioned to the anterior side of the support block 12 and is held between the support block 12 and a bulbous stop 22 formed on the distal end of the wire 8. In its passive state this spring spaces the distal end of the wire at a maximum spacing from the support block 12. When the appliance is installed, the block 12 slides towards the distal end of the wire 8, compressing the spring 20 between the block 12 and the stop 22. In this state, the spring 20 also urges the block 12 (and hence the tooth to which it is attached by the clasp 16) anteriorly. This ‘pushing’ force adds to the ‘pulling’ force applied by the other spring 18, so that together the urge the tooth forward to close the space S.

One problem that can be encountered when moving teeth in order to close spaces between them is that the force applied to the teeth causes them to tip. For instance, pulling on the posterior side of a tooth may cause the occlusal surface of the tooth to tip forwards. Clearly this is undesirable.

The embodiment of FIGS. 2 to 4 is adapted to include features that resist this tipping of the tooth. Specifically, as best seen in FIGS. 3 and 4, and upper face 24 of the support block 12 of the posterior component 6 is configured to engage with the underside and rear of an attachment 26 that has been bonded to the lingual (i.e. inside) surface of the tooth.

With this arrangement, if the tooth has a tendency to tip, the attachment 26 presses against the upper surface 24 of the block 12. This in turn causes the block 12 to compress slightly and/or the wire 8 to bend. The resilience of this block 12 and/or the wire 8 mean that this deformation/compression give rise to a restoring force acting against the tipping motion of the tooth, thus resisting the tipping. This same concept can be applied to other space closing appliances, including for example those that rely on screw closings, as well as fixed space closing appliances.

The embodiment of FIGS. 5 to 8b is similar to previous embodiments, except for its use of a modified version of the springs 18, 20. The modified spring 180 is designed to minimize interference with the sliding of the posterior component over the wire 8.

The spring 180 is a coil spring, the wire 8 extending through the coils of the spring 180. The spring has two connection portions 182, one connection portion 182 being provided at either of its ends. Each connection portions 182 comprise an eye 184 on the end of an arm 186.

The arm may be L-shaped. The eye 184 is arranged to connect to a respective hook 188. One hooks 188 is fixed to the side or rear of the support block 12, as shown in FIGS. 6a and 6b respectively. Another hook 188 is embedded in the anterior component 4, to the side of the wire 8, as shown in FIG. 5. The arrangement is such that the connection portions 182 of the spring 180 connect to the hooks 188 of the anterior and posterior components 4, 6 at points offset from the connection points between the wire 8 and the anterior and posterior components 4, 6.

By offsetting the connection points in this manner, the connection portions 182 of the spring 180 do not interfere with the sliding of the posterior component over the wire 8. For example, the connection portions 182 will not rub against the wire 182, and, furthermore, since only the coils of the spring 180 are present between the connection points of the wire 8 and the anterior and posterior components 4, 6, the connection portions 182 will not limit the degree to which the spring 180 can compress as the gap between the components 4,6 closes (compression of the spring 180 is illustrated generally in FIGS. 8a to 9b).

1. An orthodontic space closing appliance comprising:
an anterior component that can be secured to an anterior part of one of a patient's dental arches;
at least one posterior component that can be secured to one or more teeth in the patient's dental arch distal to teeth to which the anterior component is secured, the posterior component being slidably connected to the anterior component; and
an urging member acting on the posterior and anterior components to urge those components towards one another;
wherein the posterior component comprises a support block that is adapted to act against an underside of an attachment fixed to a lingual surface of a tooth to which the posterior component is attached, in order to apply force to resist tipping of the tooth as it is displaced anteriorly.

2. An appliance according to claim 1, wherein the anterior and posterior components of the appliance are removably secured in place.

3. The appliance according to claim 1, wherein the anterior and posterior components of the appliance are permanently fixed (e.g. bonded, cemented, etc) to the dentition.

4. An appliance according to claim 1, wherein there are two posterior components.

5. An appliance according to claim 1, wherein the, or each, posterior component is secured to only a single tooth.

6. An appliance according to claim 1, wherein the anterior component is adapted to be secured at least to the tooth immediately adjacent a gap to be closed, on the anterior side of the gap.

7. An appliance according to claim 1, wherein the posterior component is adapted to be secured to the tooth immediately to the posterior side of the gap to be closed.

8. An appliance according to claim 1, wherein the anterior component takes the form of a tooth positioner.

9. An appliance according to claim 1, wherein the anterior component is transparent.

10. An appliance according to claim 1, wherein the anterior component changes the alignment of the teeth it is covering at the same time as the appliance acts to close the space(s) between this anterior component and the posterior component(s).

11. An appliance according to claim 1, wherein the posterior component comprises a clasp.

12. An appliance according to claim 1, wherein the sliding connection between the anterior component and the posterior component comprises a tubular element fixed to the posterior component and a wire attached to the anterior component, the wire extending through the tubular element so that the tubular element can slide along the wire.

13. An appliance according to claim 1, wherein the urging member is a resilient member.

14. An appliance according to claim 13, wherein the urging member is a nickel-titanium (Ni—Ti) coil spring.

15. An appliance according to claim 1, wherein the urging member is a screw device that can be tightened to urge the anterior and posterior components towards one another.

16. A removable orthodontic space closing appliance comprising:
an anterior removable component that can be removably secured to an anterior part of one of a patient's dental arches;
at least one posterior removable component that can be removably secured to one or more teeth in the patient's dental arch distal to teeth to which the anterior component is secured, the posterior component being slidably connected to the anterior component; and
an urging member acting on the posterior and anterior components to urge those components towards one another.

17. An appliance according to claim 16, wherein there are two posterior components.

18. An appliance according to claim 17, wherein each posterior component is removably secured to a respective tooth distal to the anterior teeth of the arch to which the anterior component is secured.

19. An appliance according to claim 16, wherein the or each, posterior component is secured to only a single tooth.

20. An appliance according to claim 16, wherein the anterior component is adapted to be secured at least to a tooth immediately adjacent a gap to be closed, on the anterior side of the gap.

21. An appliance according to claim 16, wherein the posterior component is adapted to be secured to a tooth immediately to the posterior side of the gap to be closed.

22. An appliance according to claim 16, wherein the anterior removable component of is a tooth positioner.

23. An appliance according to claim 22, wherein the anterior removable component is transparent.

24. An appliance according to claim 22, wherein the anterior component changes an alignment of the teeth it is covering at the same time as the appliance acts to close space(s) between this anterior component and the posterior component.

25. An appliance according to claim 16, wherein the posterior component comprises a clasp.

26. An appliance according to claim 16, wherein the sliding connection between the anterior component and the or each posterior component comprises a tubular element fixed to the posterior component and a wire attached to the anterior component, the wire extending through the tubular element so that the tubular element can slide along the wire.

27. An appliance according to claim 16, wherein the urging member is a resilient member.

28. An appliance according to claim 27, wherein the urging member is a nickel-titanium (Ni—Ti) coil spring.

29. An appliance according to claim 16, wherein the urging member is a screw device that can be tightened to urge the anterior and posterior components towards one another.
